(19) United States
(12) Patent Application Publication
(10) Pub. No.: US 2007/0002157 A1
(43) Pub. Date: Jan. 4, 2007

(54) Image capturing apparatus

(75) Inventors: Dai Shintani, Izumi-shi (JP); Mamoru Terada, Sakai-shi (JP); Naoki Hashimoto, Toyokawa-shi (JP); Takehisa Yamaguchi, Ikoma-shi (JP); Shoichi Minato, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/357,791

(22) Filed: Feb. 17, 2006

(30) Foreign Application Priority Data
Jul. 1, 2005 (JP) JP2005-193582

(51) Int. Cl. H04N 5/222

(52) U.S. Cl. 348/333.06

(57) ABSTRACT

An image capturing apparatus comprises: a body; a display part movable relative to the body, the display part having a display screen capable of being changed in orientation according to a movement relative to the body; a detector for detecting an orientation of the display screen; and a display controller for determining an assistant index to be employed in capturing an image for face recognition according to the orientation of the display screen detected by the detector, and displaying the assistant index on the display screen.

This application is based on application No. 2005-193582 filed in Japan, the contents of which are hereby incorporated by reference.

### BACKGROUND OF THE INVENTION

1. Field of the Invention

The present invention relates to an image capturing apparatus such as a digital camera, and more particularly to an image capturing apparatus suitable for capturing an image for use in face recognition.

2. Description of the Background Art

Various types of digitized services have been widely available in recent years as a result of development in network technologies, for example, increasing the need for non face-to-face user authorization requiring no manual operation. In response, biometric authentication has been actively studied that is intended to automatically identify individuals depending on the biological characteristics of an individual. Face recognition as one of biometric authentication technologies employs a non face-to-face method, and is expected to be applied in various fields such as security by the use of a surveillance camera, search of database by the use of a face pattern as a key and the like.

Such face recognition is realized by a computer. Thus an image captured for use in face recognition should have such a degree of accuracy that it does not affect the authentication operation by the computer. In order to obtain an image that does not cause any effect upon the authentication operation, a facial image should have a suitable frame during image capture. However, a facial image for use in face recognition is not easy to have a suitable frame during capturing, especially if it is captured for example at home or in an office using a camera and not at a photo-specialty store.

A technique of capturing such a facial image is introduced for example in Japanese Patent Application Laid-Open No. 2003-317100, in which reference positions of eyes are superimposed on a live view image during capture of a facial image.

In capturing an image for use in face recognition, a person who is a subject of image capture and a person who captures an image of a subject may be the same or different. That is, a user responsible for image capture may capture an image of another person or an image of the user himself or herself.

However, the foregoing technique of capturing an image for use in face recognition is responsive only to the case where a person as a subject and a person to capture an image of a subject are different (namely, an image of a person as a subject is captured by another person), and may not be responsive to both of the cases as discussed.

### SUMMARY OF THE INVENTION

It is an object of the present invention to provide an image capturing apparatus capable of capturing an image for use in face recognition adequately, regardless of whether a user captures an image of another person or an image of the user himself or herself.

According to one aspect of the present invention, the image capturing apparatus comprises: a body; a display part movable relative to the body, the display part having a display screen capable of being changed in orientation according to a movement relative to the body; a detector for detecting an orientation of the display screen; and a display controller for determining an assistant index to be employed in capturing an image for face recognition according to the orientation of the display screen detected by the detector, and displaying the assistant index on the display screen.

Thus images can be suitably captured by using assistant indexes that are suitably applied to respective situations for capturing an image of another person and capturing an image of a user himself or herself.

According to a second aspect of the present invention, the image capturing apparatus comprises: a body; a display part; a selector for making a selection between a first mode and a second mode, the first mode being applied for allowing a person as a subject to perform a release operation and the second mode being applied for allowing a person other than a person as a subject to perform a release operation; and a display controller for determining an assistant index to be displayed on the display part for capturing an image for use in face recognition according to the selected mode, and displaying the determined assistant index.

Thus images can be suitably captured by using assistant indexes that are suitably applied to respective modes for capturing an image of another person and capturing an image of a user himself or herself.

The present invention is also intended for an image capturing method.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a digital camera;

FIG. 2 shows the structure on the rear side of the digital camera;

FIG. 3 shows the rear side of the digital camera in self capture;

FIG. 4 schematically illustrates self capture;

FIG. 5 is a block diagram showing the internal structure of the digital camera;

FIGS. 6 and 7 are flow charts showing the main operation of the digital camera;

FIG. 8 is a flow chart showing particular part of the main operation of the digital camera in detail;

FIG. 9 shows an assistant index for normal capture;

FIG. 10 shows an assistant index for self capture;

FIG. 11 shows a screen with “OK indication” appearing in normal capturing operation;

FIG. 12 shows a screen with “OK indication” appearing in self capturing operation;

FIGS. 13 through 17 each show a composite image displayed in normal capturing operation;

FIGS. 18 through 22 each show a composite image displayed in self capturing operation;

FIG. 23 shows a modification of an assistant index for normal capture;

FIG. 24 shows another modification of an assistant index for normal capture;

FIG. 25 shows a modification of an assistant index for self capture; and

FIG. 26 shows another modification of an assistant index for self capture.

### DESCRIPTION OF THE PREFERRED EMBODIMENTS

A preferred embodiment of the present invention will be discussed below with reference to drawings. In the following, a digital camera is discussed as an example of an image capturing apparatus.

<1. Structure>

<Outline of Structure>

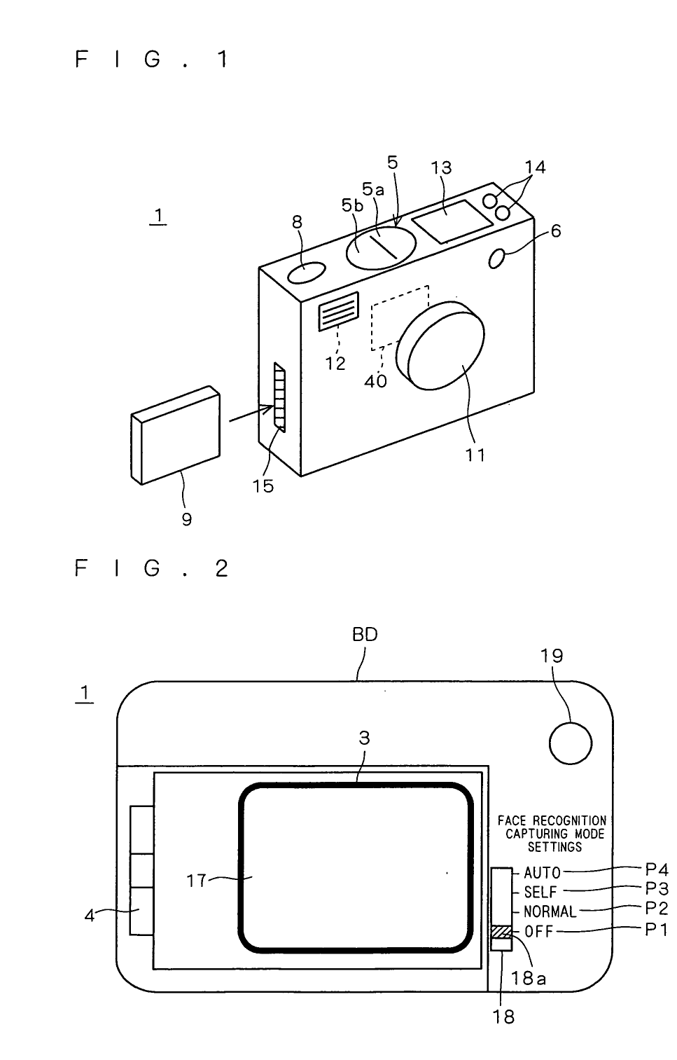

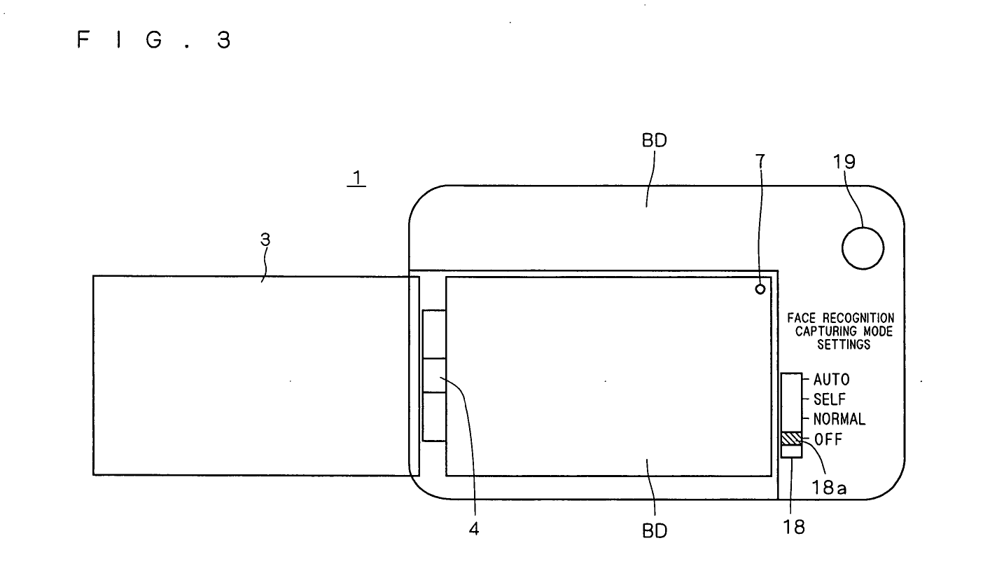

FIG. 1 is a perspective view of a digital camera 1 according to a preferred embodiment of the present invention. FIG. 2 shows the structure on the rear side of the digital camera 1.

With reference to FIG. 1, a taking lens 1, a flash 12 and an optical receiver 6 for a remote controller are provided at the front side of the digital camera 1. A CCD imaging device 40 as an image capturing element is arranged inwardly of the taking lens 11 that performs photoelectric conversion upon an image of a subject entering the CCD imaging device 40 by way of the taking lens 11.

A release button (also referred to as a shutter button) 8 to perform a release operation, a zoom button 5 responsible for optical zoom, a camera status display part 13 and a capturing condition setting switch 14 are arranged on the top surface of the digital camera 1. A user presses the release button 8 to capture an image of a subject. The release button 8 is a two-stage push-in button capable of detecting half-pressed state S1 and fully-pressed state S2. The zoom button 5 has a zoom-in button (left button) 5a and a zoom-out button (right button) 5b. A user uses the zoom-in button 5a or zoom-out button 5b to optically change the dimension (size) of an image of a subject formed on the CCD imaging device 40.

The camera status display part 13 is formed for example by a liquid crystal display of segment-display type, and is operative to show the present setting and the like of the digital camera 1 to a user. The capturing condition setting switch 14 allows change of the operating mode of the digital camera 1 by hand such as switching between “recording mode” and “playback mode”.

The recording mode has some sub-modes including a macro mode for setting a parameter suitably applicable for capturing an image of a subject at close range, a portrait mode for setting a parameter suitably applicable for capturing an image of an individual and the like, and a sport mode for setting a parameter suitably applied for capturing an image of a fast-moving subject. These settings can be manually made by using the capturing condition setting switch 14. In addition to these sub-modes (macro mode, portrait mode, sport mode and the like), the recording mode further has a face recognition capturing mode discussed later. The setting related to the face recognition capturing mode is made by using a face recognition capturing mode setting part 18.

A slot 15 is provided on the side surface of the digital camera 1 through which a memory card 9 as an interchangeable recording medium for storing image data and the like is attached to or detached from the digital camera 1.

A liquid crystal display 3 is provided on the rear surface of the digital camera 1. The liquid crystal display 3 has a display screen 17 capable of presenting an arbitrary image with several pixels. The display screen 17 of the liquid crystal display 3 is capable of showing any arbitrary images as well as images captured by the CCD imaging device 40.

When the digital camera 1 is used for image capture of a subject, the subject can be recognized in the form of so-called live view display in which images of the subject obtained by successive photoelectric conversion are presented on the liquid crystal display 3.

The liquid crystal display 3 is pivotably attached through a hinge 4 to a body BD of the digital camera 1. That is, the liquid crystal display 3 is movable relative to the body BD of the digital camera. More specifically, the liquid crystal display 3 is switched between a state SA in which the liquid crystal display 3 is folded to be in contact with the rear surface of the digital camera 1 (see FIG. 2), and a state SB in which the liquid crystal display 3 is rotated 180 degrees from the state SA with respect to the rotary shaft of the hinge 4 to be spaced from the rear surface of the digital camera 1 (see FIG. 3). In other words, in the state SA, the display screen 17 of the liquid crystal display 3 faces a side opposite to a subject (also referred to as “counter-subject side”, see FIG. 2). Likewise, in the state SB, the display screen 17 of the liquid crystal display 3 faces a subject (also referred to as “subject side”, see FIG. 3). The state SA is employed when a user captures an image of another person (normal capture). The state SB is employed when a user captures an image of the user himself or herself (self capture). In still other words, in the state SA, the display screen 17 “faces the backward direction of the digital camera 1”, whereas in the state SB, the display screen 17 “faces the forward direction of the digital camera 1”.

With reference to FIG. 3, a detector 7 is provided on the rear surface of the digital camera 1 that detects each of the states SA and SB. The detector 7 is formed by a push-in switch, and detects two states TA and TB. The state TA (pressed state) is detected when the tip of the push-in switch is in contact with the rear surface of the liquid crystal display 3 to press the push-in switch. The state TB (press-released state) is detected when the liquid crystal display 3 goes away from the digital camera 1 to release the push-in switch from the pressed state. In the preferred embodiment of the present invention, the digital camera 1 detects the state of the liquid crystal display 3 (in other words, the orientation of the display screen 17, namely, the direction to which the display screen 17 faces) according to the result of detection obtained by the detector 7. More specifically, the digital camera 1 recognizes that the liquid crystal display 3 is in the state SA (in which the display screen 17 faces the counter-subject side, see FIG. 2) when the detector 7 is in the pressed state TA. The digital camera 1 recognizes that the liquid crystal display 3 is in the state SB (in which the display screen 17 faces a subject side, see FIG. 3) when the detector 7 is in the press-released state TB.

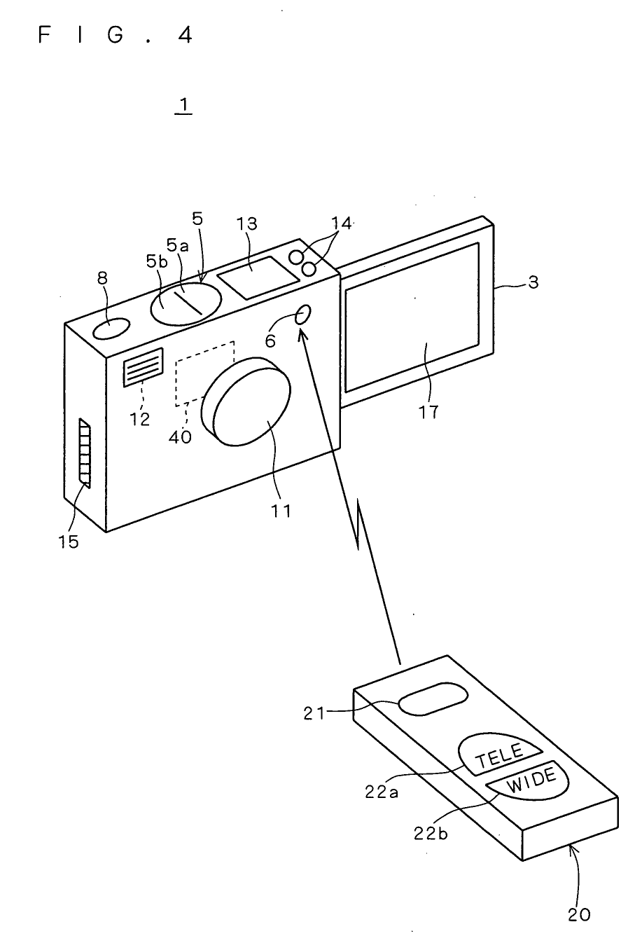

With reference to FIG. 4, the digital camera 1 is capable of receiving a signal at the optical receiver 6 sent from a remote controller 20 to realize image capture. The remote controller 20 has a release button 21, a zoom-in button 22a and a zoom-out button 22b. The release button 21 of the remote controller 20 is operative in the same manner as the release button 8 provided to the body BD. Similarly, the zoom-in button 22a and zoom-out button 22b are respectively operative in the same manner as the zoom-in button 5a and zoom-out button 5b on the body BD.

When a user captures an image of the user himself or herself (self capture), the digital camera 1 is fixedly arranged on a tripod and the like and the user seated (or standing) at a position spaced a predetermined distance from the digital camera 1 is capable of capturing a facial image of the user himself or herself by using the remote controller 20, for example. If the liquid crystal display 3 is brought to the state SB (see FIG. 3), the user is allowed to see a capturing assistant index (discussed later) and the like displayed on the display screen 17 of the liquid crystal display 3.

When a user captures an image of another person (normal capture), while looking at the display screen 17 of the liquid crystal display 3 placed in the state SA, the user performs several operations using various buttons provided to the body BD of the digital camera 1 (such as release button 8 and zoom button 5) to capture a facial image of another person.

<Internal Structure>

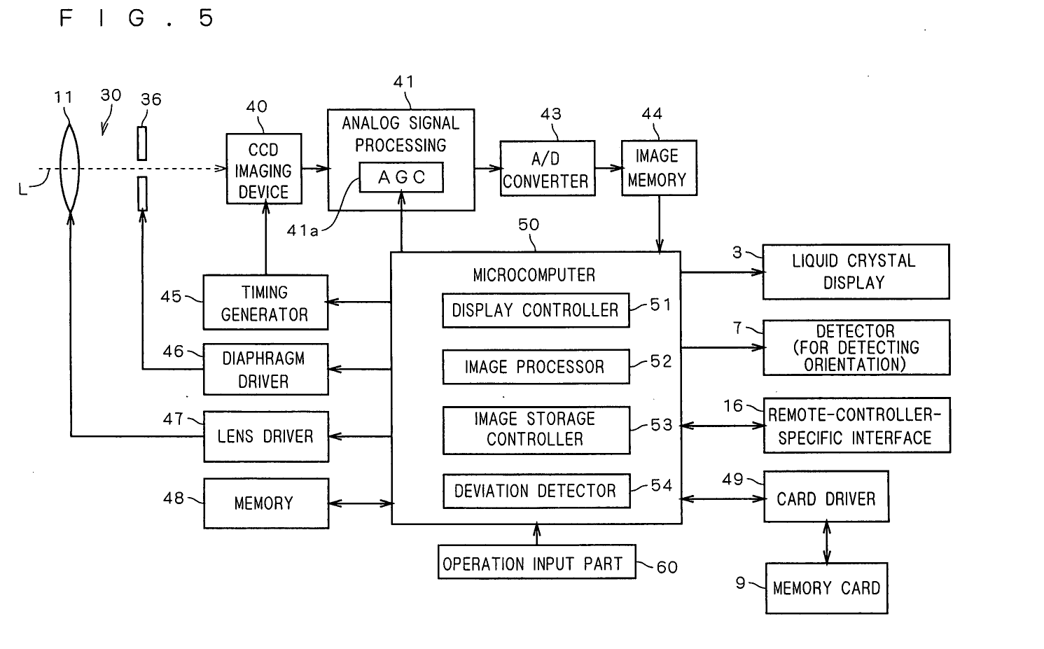

Next, the internal structure of the digital camera 1 will be described. FIG. 5 is a block diagram showing the internal structure of the digital camera 1.

With reference to FIG. 5, an image capturing optical system 30 comprises the taking lens 11 and a diaphragm plate 36. The image capturing optical system 30 serves to guide an image of a subject to the CCD imaging device 40. The taking lens 11 is driven by a lens driver 47, and is capable of changing the magnification of an image of a subject formed on the CCD imaging device 40. The diaphragm plate 36 is driven by a diaphragm driver 46, and is capable of changing its aperture (aperture diameter). The diaphragm driver 46 and the lens driver 47 respectively serve to drive the diaphragm plate 36 and the taking lens 11 based on control signals given from a microcomputer 50.

The CCD imaging device 40 has a plurality of pixels on a plane perpendicular to an optical axis L. The CCD imaging device 40 performs photoelectric conversion upon an image of a subject formed by the image capturing optical system 30 to generate and output an image signal with R (red), G (green), B (blue) color components (a sequence of pixel signals received at each pixel). A timing generator 45 controls charge accumulation time corresponding to shutter speed (more specifically, exposure start timing and exposure stop timing) at the CCD imaging device 40, thereby capturing an image of a subject. The timing generator 45 also controls for example output timing of charges accumulated by exposure of the CCD imaging device 40.

The timing generator 45 serves to generate control signals to drive the CCD imaging device 40 in this manner based on a reference clock received from the microcomputer 50.

An analog signal processing circuit 41 serves to perform predetermined analog signal processing upon an image signal (analog signal) received from the CCD imaging device 40. The analog signal processing circuit 41 has an AGC (automatic gain control) circuit 41a. The microcomputer 50 controls the gain at the AGC circuit 41a to realize level adjustment of the image signal. The analog signal processing circuit 41 also has a CDS (correlated double sampling) circuit for noise reduction of the image signal, for example.

An A/D converter 43 serves to convert each pixel signal of an image signal given from the analog signal processing circuit 41 to a digital signal for example of 10 bits. The A/D converter 43 serves to convert each pixel signal (analog signal) to a digital signal of certain bits based on a clock for A/D conversion received from an A/D clock generation circuit not shown.

An image memory 44 stores image data in the form of digital signal. The image memory 44 has a capacity of one frame.

The microcomputer 50 has a RAM and a ROM inside storing for example programs and variables. The microcomputer 50 implements various functions by executing programs previously stored inside. As an example, the microcomputer 50 is operative to function as a display controller 51 for controlling the contents displayed on the liquid crystal display 3, an image processor 52 responsible for various image processes (such as white balance control and y correction), an image storage controller 53 for recording captured images in the memory card 9, and a deviation detector 54 for detecting deviation of an image of a subject from an index for capturing a facial image (discussed later) during image capture.

The microcomputer 50 is also operative to arbitrarily control an image displayed on the liquid crystal display 3. Further, the microcomputer 50 is allowed to access a card driver 49, thereby sending and receiving data to and from the memory card 9. The digital camera 1 further comprises a memory 48. The data sent for example from the memory card 9 to the microcomputer 50 may be stored in the memory 48.

The microcomputer 50 is further operative to analyze an optical signal received at the optical receiver 6 from the remote controller 20 by way of a remote-controller-specific interface 16 to perform processing in response to this optical signal.

An operation input part 60 comprises the foregoing release button 8, a face recognition capturing mode setting part 18 and other operation parts. Operation information given from a user is sent to the microcomputer 50 by way of the operation input part 60. Then the microcomputer 50 becomes operative to perform processing responsive to the operation by the user.

<Face Recognition Capturing Mode>

As discussed above, the digital camera 1 has a face recognition capturing mode for capturing an image for use in face recognition. The face recognition capturing mode has three sub-modes including: (1) a normal mode in which a user captures a facial image of another person; (2) a self mode in which a user captures a facial image of the user himself or herself; and (3) an automatic mode in which the digital camera 1 automatically selects the normal or self mode.

Returning to FIG. 2, the face recognition capturing mode setting part 18 is provided on the rear surface of the digital camera 1 for selecting the mode for capturing an image for use in face recognition.

The face recognition capturing mode setting part 18 has a mode selection switch 18a. A user is allowed to set the mode selection switch 18a to any of four positions P1, P2, P3 and P4.

When the mode selection switch 18a is set to the lowest position P1, the face recognition capturing mode is off and capturing mode other than the face recognition capturing mode (such as sport mode) is selected.

When the mode selection switch 18a is set to any one of the positions P2, P3 and P4, the face recognition capturing mode is on. More specifically, when the mode selection switch 18a is set to the position P2 (NORMAL) directly above the lowest position P1, the normal mode is selected and the content suitable for capturing an image of another person for face recognition is displayed on the display screen 17. When the mode selection switch 18a is set to the position P3 (SELF) directly above the position P2, the self mode is selected and the content suitable for capturing an image of a user himself or herself for face recognition is displayed on the display screen 17. Thus if the mode selection switch 18a is set either to the position P2 or P3, a mode according to the actual capturing condition can be reliably selected from the normal and self modes as intended by a user. When the mode selection switch 18a is intentionally set to a mode (either normal or self mode) different from a proper mode corresponding to the actual capturing condition, a content corresponding to a capturing condition different from the actual capturing condition is allowed to be forcibly displayed by user's intention.

When the mode selection switch 18a is set to the highest position P4 (AUTO), according to the result of detection obtained by the detector 7 as discussed (FIG. 3), namely, according to the orientation of the display screen 17, selection is automatically made between the normal and self modes. Content to be displayed (including assistant index for capturing an image for use in face recognition and the like) is suitably changed (determined) according to the detected capturing condition. Then the determined content such as assistant index is displayed on the display screen 17. More specifically, when the result of detection shows that the display screen 17 faces a counter-subject side, the normal mode is selected and content suitable for normal capture (including an index MA for normal capture discussed later) is displayed on the display screen 17. When the result of detection shows that the display screen 17 faces a subject side, the self mode is selected and content suitable for self capture (including an index MB for self capture discussed later) is displayed on the display screen 17.

When the mode selection switch 18a is set to “AUTO”, the digital camera 1 automatically and suitably determines whether the capturing condition is normal capture or self capture. Thus a suitable assistant index (also referred to as capturing assistant index) for capturing an image for use in face recognition and the like can be presented. This provides a considerably high level of convenience.

<2. Operation>

<Outline of Operation>

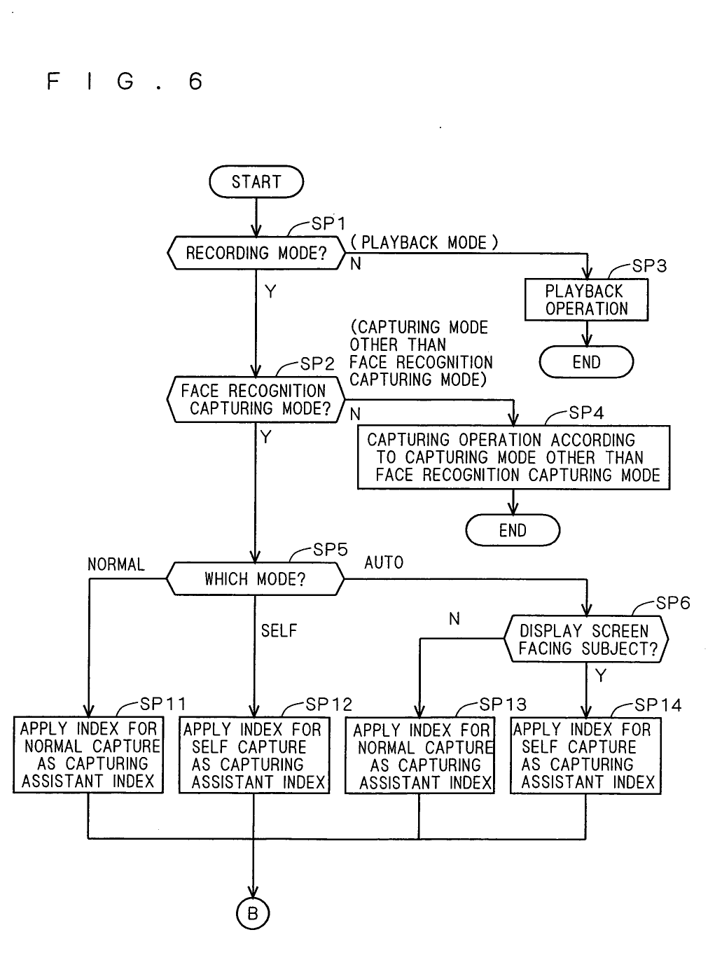

Next, the operation of the digital camera 1 will be discussed with reference to FIGS. 6 to 8 and others. FIGS. 6 and 7 are flow charts showing the main operation of the digital camera 1. FIG. 8 is a flow chart showing particular part (step SP30) of the main operation of the digital camera 1 in detail.

First, it is determined whether the digital camera 1 is in the recording mode (step SP1). If the digital camera 1 is in the recording mode, it is further determined whether the face recognition capturing mode is selected (step SP2). If the digital camera 1 is not in the recording mode (namely, if the digital camera 1 is in the playback mode), the flow proceeds to step SP3 to perform playback operation. If the digital camera 1 is in the recording mode but the face recognition capturing mode is not employed, the flow proceeds to step SP4 in which image capture according to each sub-mode (macro mode, portrait mode and sport mode) is performed that is accompanied by preview display (live view display). If the face recognition capturing mode is selected, the flow proceeds to step SP5.

In step SP5, it is determined which of the “NORMAL”, “SELF” and “AUTO” modes is selected by the mode selection switch 18a.

If the mode selection switch 18a is set to “NORMAL”, it is determined the index MA for normal capture should be displayed as a capturing assistant index on the display screen 17 (step SP11).

If the mode selection switch 18a is set to “SELF”, it is determined the index MB for self capture should be displayed as a capturing assistant index on the display screen 17 (step SP12).

If the mode selection switch 18a is set to “AUTO”, it is determined whether the display screen 17 is in the state SA in which the display screen 17 faces a counter-subject side, or in the state SB in which the display screen 17 faces a subject side (step SP6). If the display screen 17 is in the state SA, it is determined the normal capturing mode is selected so the same step as in the normal mode is followed. More specifically, it is determined the index MA for normal capture should be displayed as a capturing assistant index on the display screen 17 (step SP13). If the display screen 17 is in the state SB, it is determined the self capturing mode is selected so the same step as in the self mode is followed. More specifically, it is determined the index MB for self capture should be displayed as a capturing assistant index on the display screen 17 (step SP14).

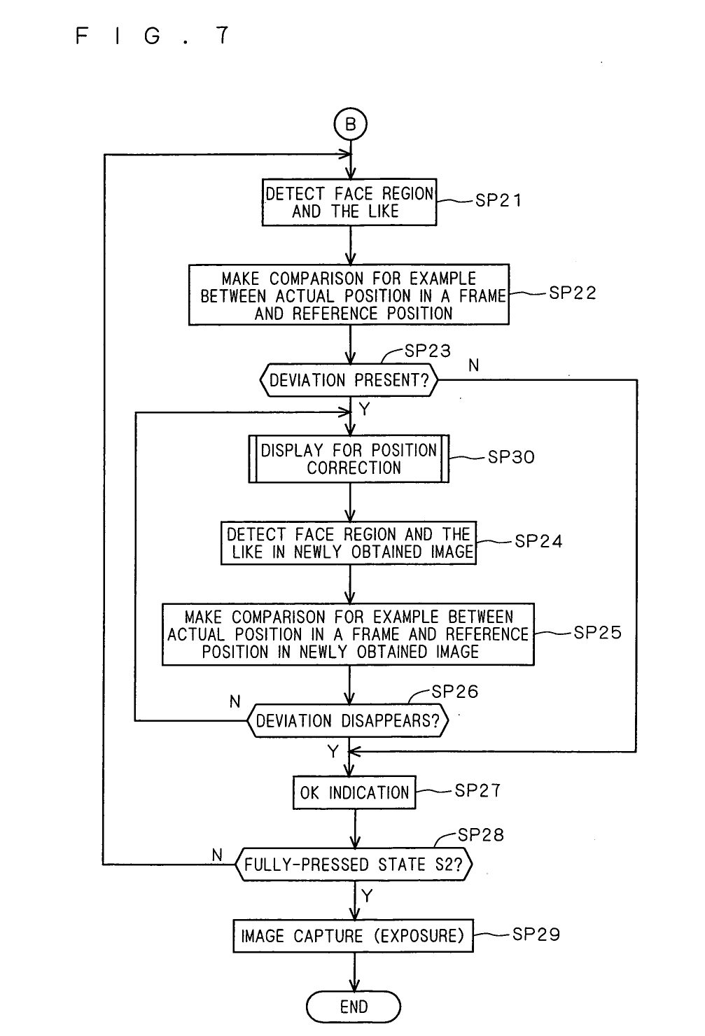

FIG. 9 shows the index MA for normal capture. As shown in FIG. 9, in the preferred embodiment of the present invention, a pattern representing a person's figure (more specifically, a pattern representing the contour of a person's face, shoulder and the like) is used as the index MA for normal capture. When a framing operation is performed in normal capture, the index MA for normal capture appears on the display screen 17. A user adjusts the position, dimension (size) and the like of the face of a subject appearing on the display screen 17 in the form of live view display referring to the index MA for normal capture, thereby performing a framing operation for capturing a suitable image for use in face recognition. The user sees the display screen 17 from a position relatively close to the digital camera 1 in normal capture. Thus the use of a particular pattern such as that shown in FIG. 9 as a capturing assistant index is preferable to realize display that is easy to recognize by intuition.

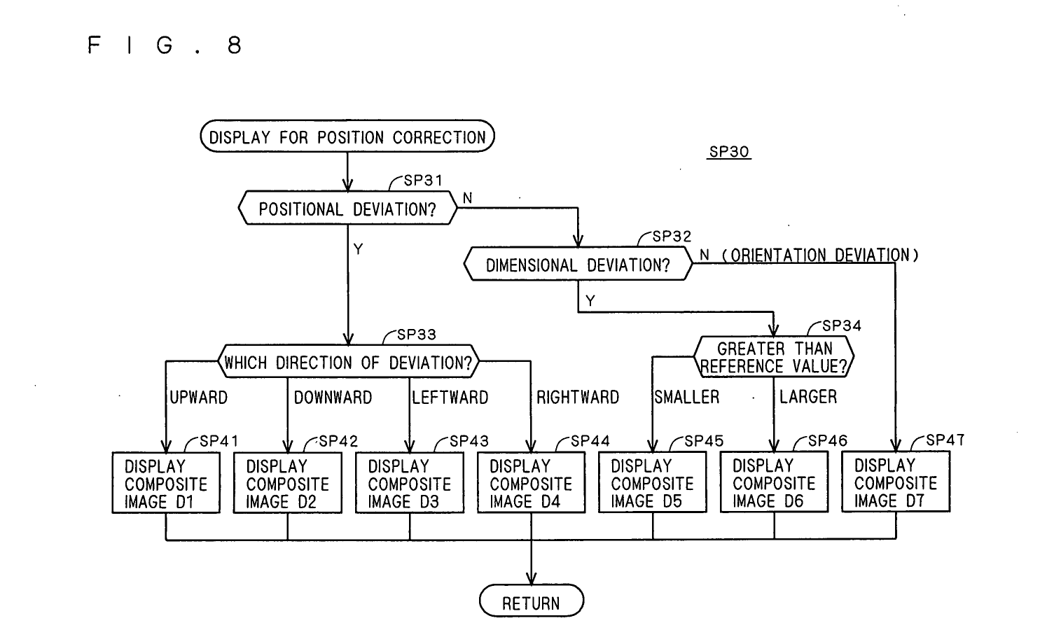

FIG. 10 shows the index MB for self capture. As shown in FIG. 10, in this preferred embodiment of the present invention, a pattern simpler than the index MA for normal capture (more specifically, a circle) is used as the index MB for self capture. When a framing operation is performed in self capture, the index MB for self capture appears on the display screen 17. A user adjusts the position, dimension and the like of the face of the user himself or herself appearing on the display screen 17 according to the index MB for self capture, thereby performing a framing operation for capturing a suitable image for use in face recognition. The user sees the display screen 17 from a position relatively far from the digital camera 1 in self capture, meaning that the display screen 17 looks relatively small. Even in this case, a capturing assistant index can be clearly recognized by using a simple (plain) pattern such as that shown in FIG. 10.

Next, in step SP21 (FIG. 7) and in subsequent steps, a framing operation is performed based on a live view image and the like.

More specifically, in step SP21, a face region is extracted from a captured image for use in live view display. Then the position, dimension and the like of this face region are detected. More particularly, by performing pattern matching and/or suitable image processing such as extraction of a skin color region, a face region is extracted and the position and dimension of the face are obtained. The position, dimension and the like of each component of the face (such as eyes, mouth, nose and ears) can also be obtained. The orientation of the face (tilt in a horizontal direction) may also be obtained according to the positional relationship between the eyes and nose, for example.

Next, in step SP22, the actual position, dimension and orientation (posture) of a face in a frame (live view image) are compared with a reference position, a reference dimension and a reference posture of a face, respectively. Then it is determined whether the actual position and the like of the face of a subject person falls within a permissible range of the reference position and the like. Here, respective adequate values required for an image for use in face recognition may be previously determined as the reference position, reference dimension and reference posture of a face.

If the difference for example between the actual position of a subject in a frame and the reference position falls within a permissible range, it is determined that no “deviation” is present. If the difference for example between the actual position of a subject and the reference position goes out of the permissible range, it is determined that “deviation” is present. In the preferred embodiment of the present invention, “deviation” includes “positional deviation”, “dimensional deviation” and “orientation deviation”.

In step SP23, it is determined whether or not “deviation” is present to divide the process flow into branches.

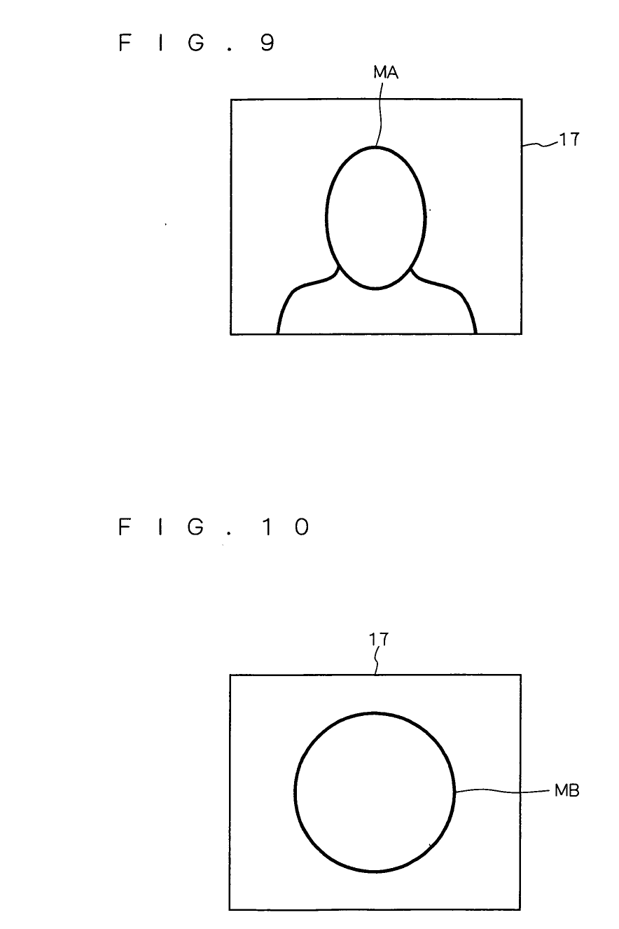

If it is determined that no “deviation” is present, the flow proceeds to step SP27 in which “OK indication” (FIGS. 11 and 12) appears on the display screen 17 indicating that a frame is suitably created. Thereafter the flow proceeds to step SP28.

As an example, the “OK indication” displayed in step SP27 may be an OK mark MZ. More specifically, in the normal mode, the index MA for normal capture and the OK mark MZ are superimposed on a live view image to form a composite image on the display screen 17 as shown in FIG. 11. In the self mode, a circular mark (abstract pattern) MC indicating the actual position, dimension and the like of a subject, the index MB for self capture and the OK mark MZ are combined to form a composite image on the display screen 17 as shown in FIG. 12. The abstract pattern MC will be discussed later. Alternatively, the absence of “deviation” may be notified by causing the indexes MA and MB to flash, for example.

If it is determined that “deviation” is present, the flow proceeds to step SP30 to make a display for position correction discussed later.

After step SP30, a newly obtained live view image is subjected to detection of a face region and the like (step SP24), and comparison in a frame (step SP25) in which the actual position and the like of the detected face region and the reference position are compared. Steps SP24 and SP25 are respectively the same as steps SP21 and SP22.

If it is determined that “deviation” is still present, the flow returns to step SP30 to repeat steps SP24, SP25 and SP26. Such a flow of steps is repeated until “deviation” disappears. Thus exposure for actual image capture (step SP29) is not started when “deviation” does not disappear.

If it is determined that “deviation” disappears, the flow proceeds to step SP27 in which “OK indication” (step SP27) appears. Thereafter the flow goes to step SP28.

In step SP28, it is determined whether or not the release button 8 or 21 is in the fully-pressed state S2. If not, the flow returns to step S21 to repeat the aforementioned operations. If the release button 8 or 21 is judged to be in the fully-pressed state S2, the flow proceeds to step S29 to perform exposure for actual image capture, thereby capturing an image for use in face recognition.

<Display for Position Correction>

Next, it will be discussed how a display for position correction is made in step SP30.

With reference to FIG. 8, the flow is divided into branches in steps SP31 and SP32 depending on a type of “deviation” including “positional deviation”, “dimensional deviation” and “orientation deviation”.

If a type of “deviation” is “positional deviation”, the direction of deviation (upward, downward, leftward or rightward deviation) is further determined (step SP33) to realize correction according to the direction of deviation. More specifically, a composite image D1 is displayed on the display screen 17 if the position of a subject deviates “upward” from the reference position in a frame (step SP41). A composite image D2 is displayed on the display screen 17 if the position of a subject deviates “downward” from the reference position in a frame (step SP42). A composite image D3 is displayed on the display screen 17 if the position of a subject deviates “leftward” from the reference position in a frame (step SP43). A composite image D4 is displayed on the display screen 17 if the position of a subject deviates “rightward” from the reference position in a frame (step SP44).

If a type of “deviation” is “dimensional deviation”, it is further determined whether a subject has a dimension larger or smaller than the reference dimension (step SP34) to realize correction according to the result. More specifically, a composite image D5 is displayed on the display screen 17 if a subject has a dimension “smaller” than the reference dimension in a frame (step SP45). A composite image D6 is displayed on the display screen 17 if a subject has a dimension “larger” than the reference dimension in a frame (step SP46).

If a type of “deviation” is “orientation deviation”, a composite image D7 is displayed on the display screen 17 (step SP47).

The composite images D1 through D7 respectively include two types of images, one being formed by using the index MA for normal capture (images DA1 through DA7), and the other being formed by using the index MB for self capture (images DB1 through DB7). If it is determined the index MA for normal capture should be used as a capturing assistant index (namely, if it is determined the normal capture mode is selected) in step SP11 or SP13 as discussed above, the composite images DA1 through DA7 are formed and used. If it is determined the index MB for self capture should be used as a capturing assistant index (namely, if it is determined the self capturing mode is selected) in step SP12 or SP14 as discussed above, the composite images DB1 through DB7 are formed and used.

First, the display for capturing assistant using the index MA for normal capture will be discussed. In this case, the composite images D1 through D7 (DA1 through DA7) are each formed by superimposing the index MA for normal capture (FIG. 9) onto a live view image. An indication suggesting an operation to reduce deviation also appears on each of the composite images. The display screen 17 faces a counter-subject side and the display screen 17 is seen from a relatively close position in the normal capturing mode. Thus by superimposing the index MA for normal capture on a live view image, the condition of deviation of a subject from an assistant index can be precisely understood.

As an example, if the face of a subject deviates leftward from the reference position, the composite image DA3 (D3) as shown in FIG. 13 is displayed on the display screen 17. The composite image DA3 includes the index MA for normal capture placed in the reference position (center of the screen), and the subject in a live view image deviating leftward from the index MA for normal capture. The composite image DA3 further includes characters giving instruction to “move the camera to the left” to suggest an operation to reduce the deviation. A user seeing the composite image DA3 moves the camera to the left, thereby realizing fine adjustments of the position of the face.

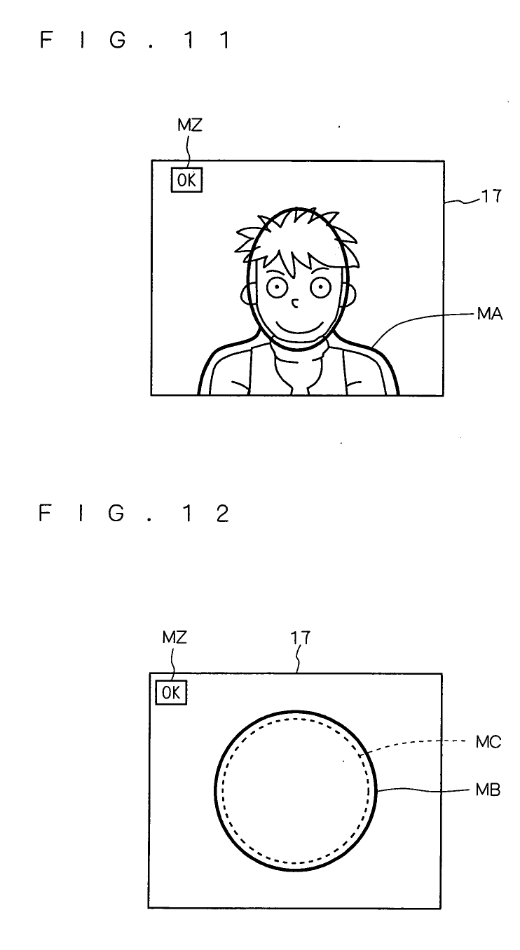

If the face of a subject deviates downward from the reference position, the composite image DA2 (D2) as shown in FIG. 14 is displayed on the display screen 17. The composite image DA2 includes the index MA for normal capture placed in the reference position, and the subject in a live view image deviating downward from the index MA for normal capture. The composite image DA2 further includes characters giving instruction to “move the camera downward” to suggest an operation to reduce the deviation. A user seeing the composite image DA2 moves the camera downward, thereby realizing fine adjustments of the position of the face.

Likewise, if the face of a subject deviates rightward or upward from the reference position, the composite image DA4 (D4) or DA1 (D1) is displayed on the display screen 17. A user seeing the composite image DA4 or DA1 is capable of making fine adjustments of the position of the face of the subject.

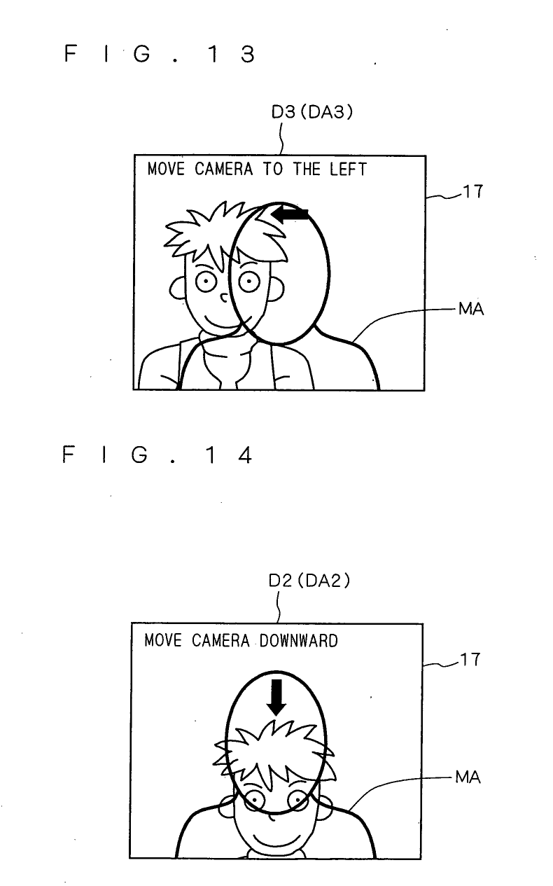

If the face of a subject has a dimension smaller than the reference dimension, the composite image DA5 (D5) as shown in FIG. 15 is displayed on the display screen 17. The composite image DA5 includes the index MA for normal capture with the reference dimension, and the subject in a live view image smaller in dimension than the index MA for normal capture. The composite image DA5 further includes characters giving instruction to “zoom in” to suggest an operation to reduce the deviation. A user seeing the composite image DA5 presses the zoom-in button 5a, thereby realizing fine adjustments of the dimension of the face.

If the face of a subject has a dimension larger than the reference dimension, the composite image DA6 (D6) as shown in FIG. 16 is displayed on the display screen 17. The composite image DA6 includes the index MA for normal capture with the reference dimension, and the subject in a live view image larger in dimension than the index MA for normal capture. The composite image DA6 further includes characters giving instruction to “zoom out” to suggest an operation to reduce the deviation. A user seeing the composite image DA6 presses the zoom-out button 5b, thereby realizing fine adjustments of the dimension of the face.

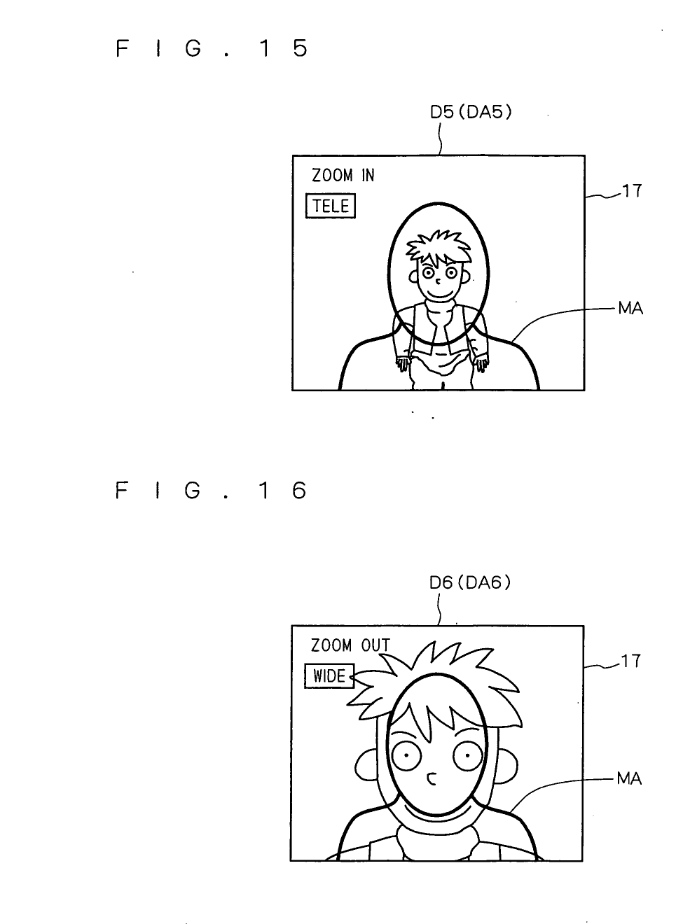

If the orientation of the face of a subject deviates from the reference posture (here, forward-facing posture) to an extent considerably exceeding a predetermined angle (±five degrees), the composite image DA7 as shown in FIG. 17 is displayed on the display screen 17. The composite image DA7 includes the index MA for normal capture in the reference posture, and the subject in a live view image facing sideways. The composite image DA7 further includes characters giving instruction to “have the subject turn to a user (to the right)” to suggest an operation to reduce the deviation. Then the user seeing the composite image DA7 talks to the subject to ask him/her to turn his/her face to the user (to the right as viewed from the subject).

Next, the display for capturing assistant using the index MB for self capture will be discussed. In this case, a live view image himself or herself is not displayed on the display screen 17. Instead, the abstract pattern (simple pattern) MC for representing the condition of a subject (more specifically, the position, dimension and orientation of the subject) extracted from a live view image and the index MB for self capture (FIG. 10) are combined to form the composite images D1 through D7 (DB1 through DB7). The display screen 17 faces a subject side so a user sees the display screen 17 from a relatively spaced position. This means the display screen 17 looks small and is hard to recognize. In response, the condition of a subject extracted from a live view image is represented in the form of abstract and simple pattern. This provides enhanced visibility as compared to the display in which a live view image containing pieces of information of various kinds is displayed as it is, whereby the present condition of a subject can be easily understood.

In the self capturing mode, the abstract pattern MC is located at a position in a horizontally reversed live view image (mirror image) displayed on the display screen 17. When an image viewed from the camera is horizontally reversed, the problem that the left and right of a view from the camera and the left and right of a view from a subject facing the camera are reversed is overcome. Thus a user who is also a subject can recognize by intuition the positional deviation of the user himself or herself, thereby easily controlling the positional deviation.

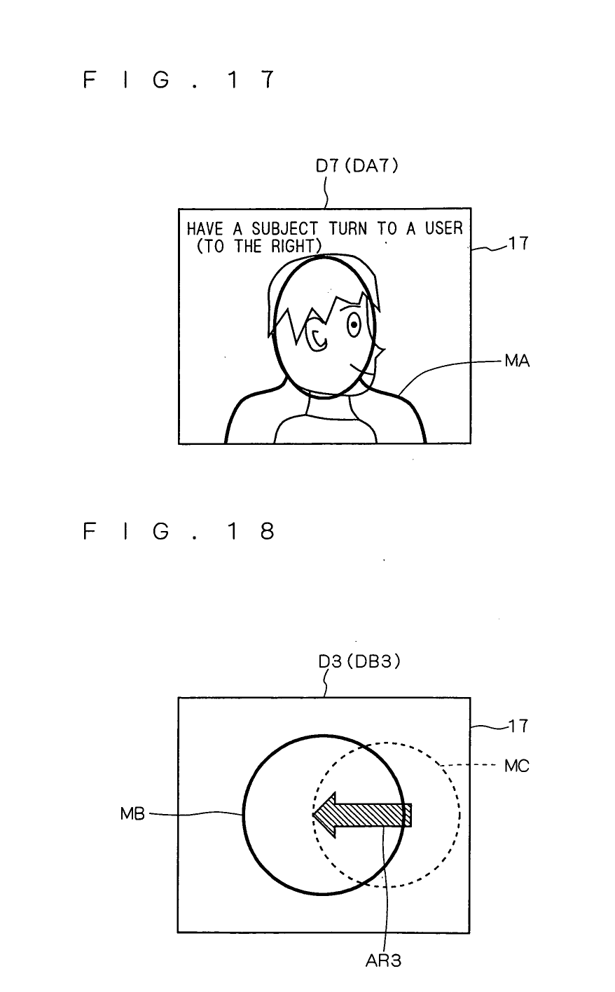

As an example, if the face of a subject deviates leftward from the reference position in a frame, the composite image DB3 (D3) as shown in FIG. 18 is displayed on the display screen 17. The composite image DB3 has been subjected to horizontal reversion, and hence the abstract pattern MC representing the condition of the subject deviates rightward from the index MB for self capture. A user (who is also the subject) seeing the composite image DB3 can easily understand the positional deviation is overcome by moving to the left as viewed from the subject. The composite image DB3 further includes a left arrow AR3 suggesting an operation to reduce the deviation. The user seeing the composite image DB3 moves him/herself to the left, thereby realizing fine adjustments of the position of the face.

If the face of a subject deviates downward from the reference position, the composite image DB2 (D2) as shown in FIG. 19 is displayed on the display screen 17. In the composite image DB2, the abstract pattern MC representing the condition of the subject deviates downward from the index MB for self capture. The composite image DB2 further includes an up arrow AR2 suggesting an operation to reduce the deviation. A user seeing the composite image DB2 shifts the face of the user himself or herself upward, thereby realizing fine adjustments of the position of the face.

Likewise, if the face of a subject deviates rightward or upward from the reference position, the composite image DB4 (D4) or DB1 (D1) is displayed on the display screen 17. A user seeing the composite image DB4 or DB1 is capable of making fine adjustments of the position of the face of the subject.

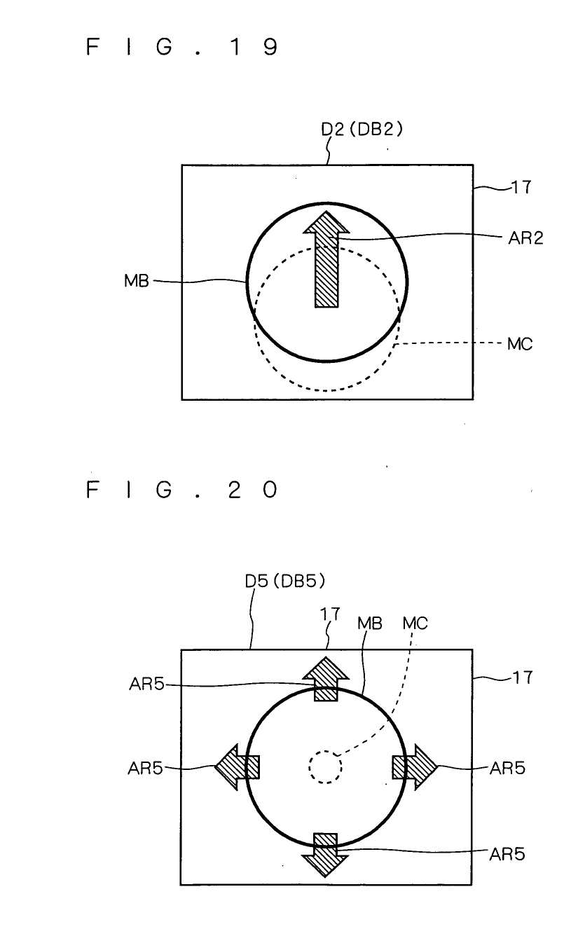

If the face of a subject has a dimension smaller than the reference dimension, the composite image DB5 (D5) as shown in FIG. 20 is displayed on the display screen 17. In the composite image DB5, the abstract pattern MC representing the condition of the subject is shown to be smaller in dimension than the index MB for self capture. The composite image DB5 further includes four outward arrows AR5 (extending outward from the center of the screen) suggesting an operation to reduce the deviation. A user seeing the composite image DB5 presses the zoom-in button 22a of the remote controller 20, thereby realizing fine adjustments of the dimension of the face.

If the face of a subject has a dimension larger than the reference dimension, the composite image DB6 (D6) as shown in FIG. 21 is displayed on the display screen 17. In the composite image DB6, the abstract pattern MC representing the condition of the subject is shown to be larger in dimension than the index MB for self capture. The composite image DB6 further includes four inward arrows AR6 (extending inward toward the center of the screen) suggesting an operation to reduce the deviation. A user seeing the composite image DB6 presses the zoom-out button 22b of the remote controller 20, thereby realizing fine adjustments of the dimension of the face.

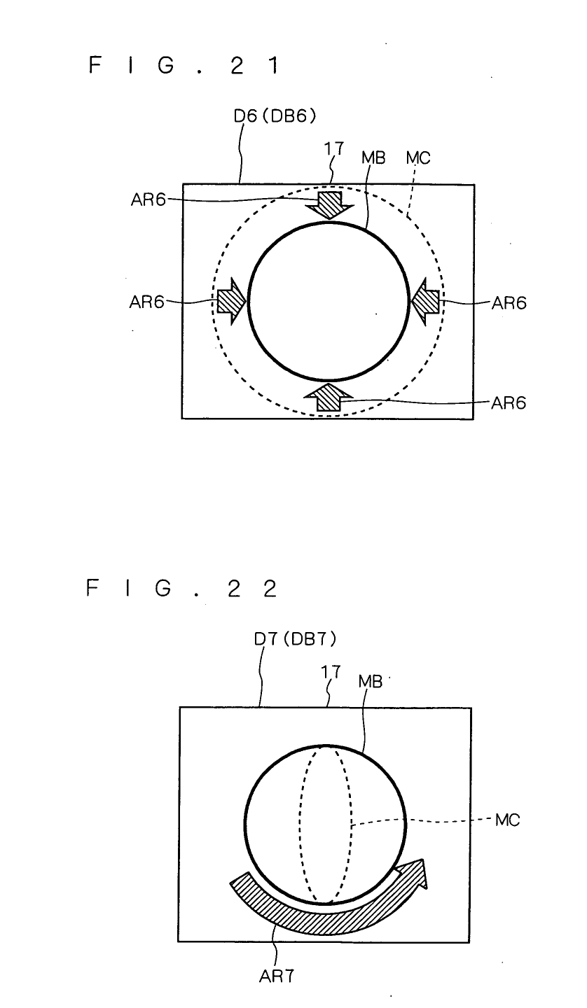

If the orientation of the face of a subject deviates from the reference posture (here, forward-facing posture) to an extent considerably exceeding a predetermined angle (+five degrees), the composite image DB7 (D7) as shown in FIG. 22 is displayed on the display screen 17. In the composite image DB7, the abstract pattern MC representing the condition of the subject is shown to be narrower (more specifically, in the form of a vertically extending ellipse) than the index MB for self capture, indicating that the orientation of the subject deviates from the reference posture. The composite image DB7 further includes a curved right arrow AR7 suggesting an operation to reduce the deviation. Then a user seeing the composite image DB7 turns the face of the user himself or herself rightward, thereby approximating the posture of the face to the reference posture.

As discussed, when the capturing mode for capturing an image for use in face recognition, and especially the automatic mode is selected, either the index MA or MB is selected as an assistant index for capturing an image for use in face recognition according to the result of detection obtained by the detector 7 (more specifically, the orientation of the display screen 17). Then the selected index is displayed on the display screen 17 (see steps SP6, SP13 and SP14 in FIG. 6). Thus by the use of the index MA for capturing an image of another person and the use of the index MB for capturing an image of a user himself or herself, images can be captured in a suitable manner. Namely, images can be suitably captured by using assistant indexes that are suitably applied to respective situations for capturing an image of another person and capturing an image of a user himself or herself.

A superimposed combination of a live view image and the assistant index MA is displayed on the display screen 17 in the normal capturing operation. Thus the condition of deviation of a subject from the assistant index MA can be precisely understood. The assistant index MA displayed on the display screen 17 represents a person's figure, thereby realizing display easily that is easy to recognize by intuition.

A live view image himself or herself is not displayed on the display screen 17 in the self capturing operation. Instead, a superimposed combination of the pattern MC extracted from a live view image and representing the condition of a subject and the assistant index MB is displayed on the display screen 17. This provides enhanced visibility as compared to the display in which a live view image containing pieces of information of various kinds is displayed as it is, whereby the present condition of a subject can be easily understood. The assistant index MB is displayed in the form of a relatively simple pattern on the display screen 17, thereby providing enhanced visibility.

The composite images D1 through D7 each include an indication that suggests an operation to reduce deviation, whereby a required operation can be easily understood.

<3. Modifications>

The present invention is not limited to the preferred embodiment described above.

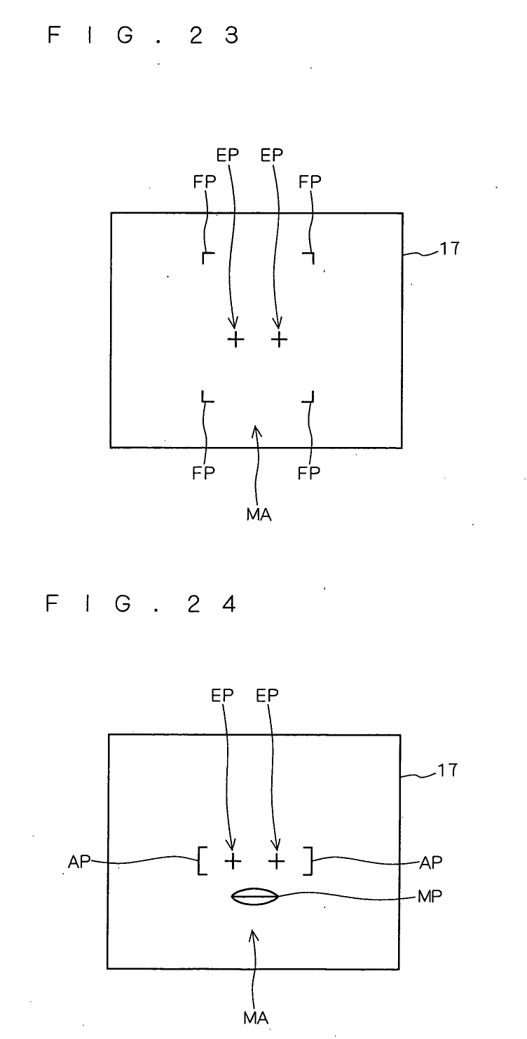

As an example, a pattern representing a person's figure is used as the index MA for normal capture (FIG. 9) in the preferred embodiment described above. Alternatively, the index MA for normal capture may be defined by signs FP representing the positions of a face of a person (four corners of a face) and signs EP representing the positions of eyes as shown in FIG. 23. Still alternatively, signs EP, MP and AP respectively representing the positions of eyes, mouth and ears of a person may be used as shown in FIG. 24.

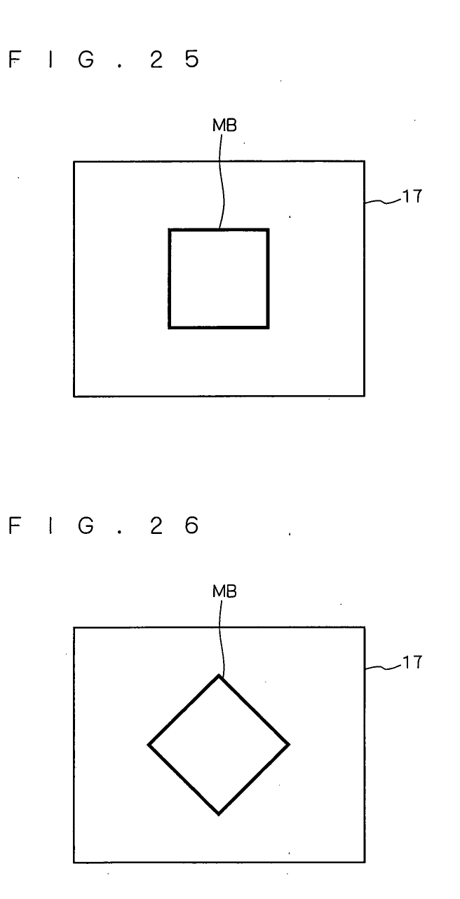

In the preferred embodiment described above, a circular mark is used as the index MB for self capture (FIG. 10). Alternatively, a rectangular mark (see FIG. 25) or rhombic mark (see FIG. 26) may be used.

Still alternatively, the index MB for self capture and the abstract pattern MC may be defined by different types of lines and/or different colors of lines to provide increased distinction between the index MB and the pattern MC. As an example, the index MB for self capture may be defined by a red solid line whereas the abstract pattern MC may be defined by a black dashed line.

The detection and comparison at steps SP24 and SP25 (FIG. 7) are not necessarily performed upon all live view images, but upon only some of the live view images. As an example, of live view images sequentially obtained at intervals of 1/30 seconds, only those live view images sequentially obtained at intervals of 1 seconds may be subjected to detection and comparison at steps SP24 and SP25.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus, comprising:
a body;
a display part movable relative to said body, said display part having a display screen capable of being changed in orientation according to a movement relative to said body;
a detector for detecting an orientation of said display screen; and
a display controller for determining an assistant index to be employed in capturing an image for face recognition according to the orientation of said display screen detected by said detector, and displaying said assistant index on said display screen.

2. The image capturing apparatus according to claim 1,
wherein when said display screen faces a counter-subject side, said display controller displays a combination of a live view image and said assistant index on said display screen.

3. The image capturing apparatus according to claim 1,
wherein when said display screen faces a subject side, said display controller displays a combination of a pattern and said assistant index on said display screen, said pattern representing a condition of a subject extracted from a live view image.

4. The image capturing apparatus according to claim 1,
wherein when said display screen faces a counter-subject side, said display controller displays a pattern representing a person's figure as said assistant index on said display screen.

5. The image capturing apparatus according to claim 1,
wherein when said display screen faces a subject side, said display controller displays a pattern as said assistant index on said display screen, said pattern being simpler than a pattern displayed on said display screen when said display screen faces a counter-subject side.

6. The image capturing apparatus according to claim 1, further comprising:
a deviation detector for detecting deviation of a subject in a frame from said assistant index,
wherein said display controller further displays an indication on said display screen, said indication suggesting an operation to reduce the deviation detected by said deviation detector.

7. An image capturing method, comprising the steps of:
a) detecting an orientation of a display screen of an image capturing apparatus, said display screen being provided on a display part being movable relative to a body of said image capturing apparatus; and
b) determining an assistant index to be employed in capturing an image for face recognition according to an orientation of said display screen detected in said step a), and displaying said assistant index on said display screen.

8. The method according to claim 7,
wherein when said display screen faces a counter-subject side, a combination of a live view image and said assistant index is displayed on said display screen in said step b).

9. The method according to claim 7,
wherein when said display screen faces a subject side, a combination of a pattern and said assistant index is displayed on said display screen in said step b), said pattern representing a condition of a subject extracted from a live view image.

10. The method according to claim 7,
wherein when said display screen faces a counter-subject side, a pattern representing a person's figure is displayed as said assistant index on said display screen in said step b).

11. The method according to claim 7,
wherein when said display screen faces a subject side, a pattern is displayed as said assistant index on said display screen in said step b), said pattern being simpler than a pattern displayed on said display screen when said display screen faces a counter-subject side.

12. The method according to claim 7, further comprising the step of:
c) detecting deviation of a subject in a frame from said assistant index,
wherein an indication is further displayed on said display screen in said step b), said indication suggesting an operation to reduce the deviation detected in said step c).

13. An image capturing apparatus, comprising:
a body;
a display part;
a selector for making a selection between a first mode and a second mode, said first mode being applied for allowing a person as a subject to perform a release operation and said second mode being applied for allowing a person other than said person as a subject to perform a release operation; and
a display controller for determining an assistant index to be displayed on said display part for capturing an image for use in face recognition according to the selected mode, and displaying the determined assistant index.

14. The image capturing apparatus according to claim 13,
wherein said display part is movable relative to said body, and has a display screen capable of being changed in orientation, and
wherein said selector selects said first mode or said second mode according to the orientation of said display screen.

15. The image capturing apparatus according to claim 14, further comprising a receiver for receiving a signal from a remote controller,
wherein a person as a subject performs a release operation using said remote controller in said first mode.

16. The image capturing apparatus according to claim 14,
wherein when said display screen faces a counter-subject side, said display controller displays a combination of a live view image and said assistant index on said display screen.

17. The image capturing apparatus according to claim 14,
wherein when said display screen faces a subject side, said display controller displays a combination of a pattern and said assistant index on said display screen, said pattern representing the condition of a subject extracted from a live view image.

18. The image capturing apparatus according to claim 14,
wherein when said display screen faces a counter-subject side, said display controller displays a pattern representing a person's figure as said assistant index on said display screen.

19. The image capturing apparatus according to claim 14,
wherein when said display screen faces a subject side, said display controller displays a pattern as said assistant index on said display screen, said pattern being simpler than a pattern displayed on said display screen when said display screen faces a counter-subject side.

20. The image capturing apparatus according to claim 14, further comprising:
a deviation detector for detecting deviation of a subject in a frame from said assistant index,
wherein said display controller further displays an indication on said display screen, said indication suggesting an operation to reduce the deviation detected by said deviation detector.
